(19) United States
(12) Patent Application Publication
(10) Pub. No.: US 2010/0070588 A1
(43) Pub. Date: Mar. 18, 2010

(54) RELIABILITY FOR INSTANT MESSAGING BASED ON END POINT ACKNOWLEDGEMENTS

(75) Inventors: Richard Sinn, Milpitas, CA (US); Richard Chin, San Francisco, CA (US); Kingston Choy, Fremont, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 12/211,076

(22) Filed: Sep. 15, 2008

(51) Int. Cl. G06F 15/16

(52) U.S. Cl. 709/206

(57) ABSTRACT

A reliable IM system is disclosed including an end-to-end mechanism to make sending and receiving IM text messages more reliable. The reliable IM system may include a reliability-enabled client device server device, each including a reliability-enabled messenger component for adding message ID numbers to outgoing IM messages and sending message-specific acknowledgments (ACK) back to a sending client. The reliable IM system may resend a sequenced message N times when the message is identified as missing. The reliability-enabled client and server may be used to communicate with either reliable or non-reliable clients (for example, clients that do not have the reliability-enabled messenger component). An offline storage may be used to accept and store IM messages for offline clients while sending ACKs back for the received messages. Duplicate and lost sequenced messages are handled by deleting duplicate messages and resending lost sequenced messages at the client and/or server to maintain normal IM transactions.

### TECHNICAL FIELD

The present disclosure relates generally to instant messaging (IM), and more particularly, but not exclusively, to increasing reliability of message passing in IM through message-specific acknowledgements.

### BACKGROUND

With the ubiquity of computers and communication networks, such as the Internet, human interactions and communications have increased exponentially in recent years. More particularly, with the development of the World Wide Web (WWW) and application programs called browsers that are used as the primary interface with the WWW, users can communicate in a variety of ways. The client-server architecture is one of the most common architectures employed in utilizing the WWW, although other architectures and methods, such as peer-to-peer (P2P) and ad-hoc communications, may also be used. Other than viewing or searching for content, the browser may be used to, directly or indirectly, host applications such as media players, various business applications, etc. One of the types of applications that are implemented in conjunction with the browser, is Instant Messaging (IM). Using IM, various users, usually belonging to a group of friends defined by a “buddy list,” may interact and communicate, for example, by entering text or uploading pictures and files. IM is typically real-time and is based on messaging protocols that are streamlined to maintain the real-time performance requirements.

### BRIEF DESCRIPTION OF THE DRAWINGS

Non-limiting and non-exhaustive embodiments of the present invention are described in reference to the following drawings. In the drawings, like reference numerals refer to like parts through all the various figures unless otherwise explicit.

For a better understanding of the present disclosure, a reference will be made to the following detailed description, which is to be read in association with the accompanying drawings, wherein:

FIG. 1A is a system diagram of one embodiment of an environment in which aspects of the invention may be practiced;

FIG. 1B is a block diagram of a server architecture for an illustrative IM message processing embodiment;

FIG. 2 shows one embodiment of a client device that may be included in a system implementing aspects of the invention;

FIG. 3 shows one embodiment of a network device that may be included in a system implementing aspects of the invention;

FIGS. 4A-4G are signal diagrams depicting embodiment of general IM transactions between multiple clients and/or a server;

FIG. 5 is a block diagram of one embodiment of an illustrative format of an acknowledgment message;

FIG. 6 is a block diagram of one embodiment of an illustrative queue data structures on a client;

FIGS. 7-9 are tabular representations of illustrative receive queue transactions on a client;

FIG. 10 is a flow diagram of one embodiment of a process of receiving incoming IM messages; and

FIG. 11 is a flow diagram of one embodiment of a process of sending outgoing IM messages.

### DETAILED DESCRIPTION

The present disclosure will now be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used here, the terms “message” and “IM message” refer to a complete entry of information provided by a user that is sent over a network, and includes that information entered by the user up to and including a point at which the user transmits the entered information. Such messages are distinguished from packets, such as network packets. As a non-limiting, non-exhaustive example to clarify, consider a message to be that data a user enters, such message A of “hello, how are things going,” or message B “things are going very well with me.” These examples represent two separate complete messages. In network communications, such messages may be decomposed into network packets and transmitted using various networking protocols, such as Transmission Control Protocol (TCP), or the like. However, embodiments of the invention are directed towards managing and ensuring receipt of complete messages, and not sequences or receipt of packets that comprise a message.

With regard to the ISO-OSI (International Standards Organization-Open System Interconnection) communication model, those skilled in the art will appreciate that data, such as text, entered by the user in an IM application belong to a layer that is above the transport layer. Thus, an IM message is a data unit that is distinct from a TCP packet, even though the IM message may be broken down into TCP packets for transmission.

As used here, the terms “reliability,” “reliable,” “reliability-enabled,” and other derivative terms refer to the capabilities, techniques, and features that enable verification of receipt of IM messages sent from one client to another client, and resending of those IM messages that have not been verified to have been received by the other client.

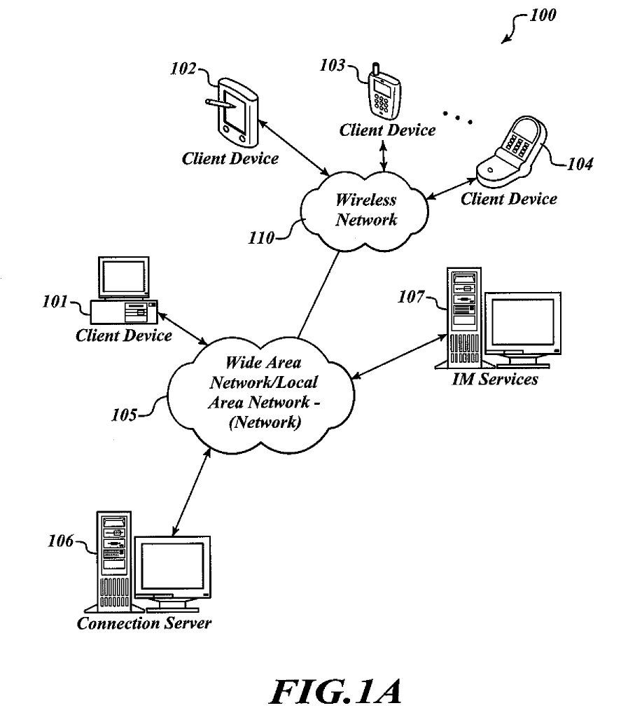

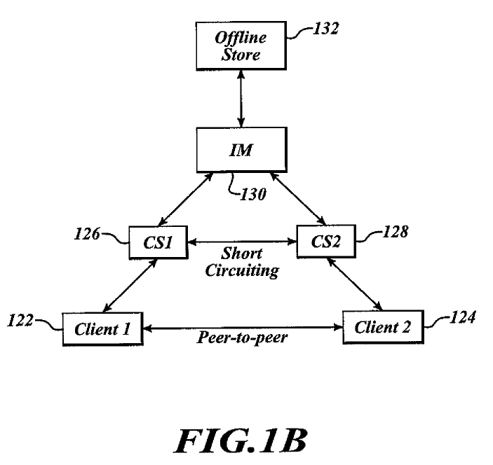

As used here, the terms “online” and “offline” refer to a client device, such as those depicted in FIG. 1A more fully described below, being operably connected to or disconnected from, respectively, a computer network for communication of information. Thus, an offline client device is considered to not be in a configuration to immediately receive and transmit messages.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly described, the present disclosure is directed to a reliable IM system. The reliable IM system includes an end-to-end mechanism to make sending and receiving IM text messages more reliable. The reliable IM system may include a reliability-enabled client device and a reliability-enabled server device, each including a reliability-enabled messenger component for adding message ID numbers to outgoing IM messages and sending message-specific acknowledgments (ACK) back to a sending client from which the IM messages were received. The reliable IM system may resend a sequenced message N times when the message is identified as having not been received. The reliability-enabled client and reliability-enabled server may be used to communicate with either reliable or non-reliable clients (for example, clients that do not have the reliability-enabled messenger component). An offline storage may be used to accept and store IM messages for offline clients while sending ACKs back for the received messages. Duplicate and lost sequenced messages are handled by deleting duplicate messages and resending lost sequenced messages at the client and/or server to maintain normal IM transactions.

Those skilled in the relevant art will appreciate that even though the present disclosure describes various embodiments in a web environment with a client-server computing architecture, the same concepts, methods, and systems may be applied to other application environments without departing from the spirit of the present disclosure. For example, the reliable messaging concepts described herein may be applied to other types of messaging systems such as Short Message Service (SMS), Multimedia Message Service (MMS), internet relay chat (IRC), Mardam-Bey's IRC (mIRC), Jabber, etc.

### Illustrative Operating Environment

FIG. 1A shows components of one embodiment of an environment in which the invention may be practiced. Not all the components may be required to practice the invention, and variations in the arrangement and type of the components may be made without departing from the spirit or scope of the invention. As shown, system 100 of FIG. 1A includes local area networks (“LANs”)/wide area networks (“WANs”)−(network) 105, wireless network 110, client devices 101-104, connection server 106, and IM services 107. Each of the devices and servers shown in FIG. 1A may represent multiple such devices coupled with networks 105 and 110.

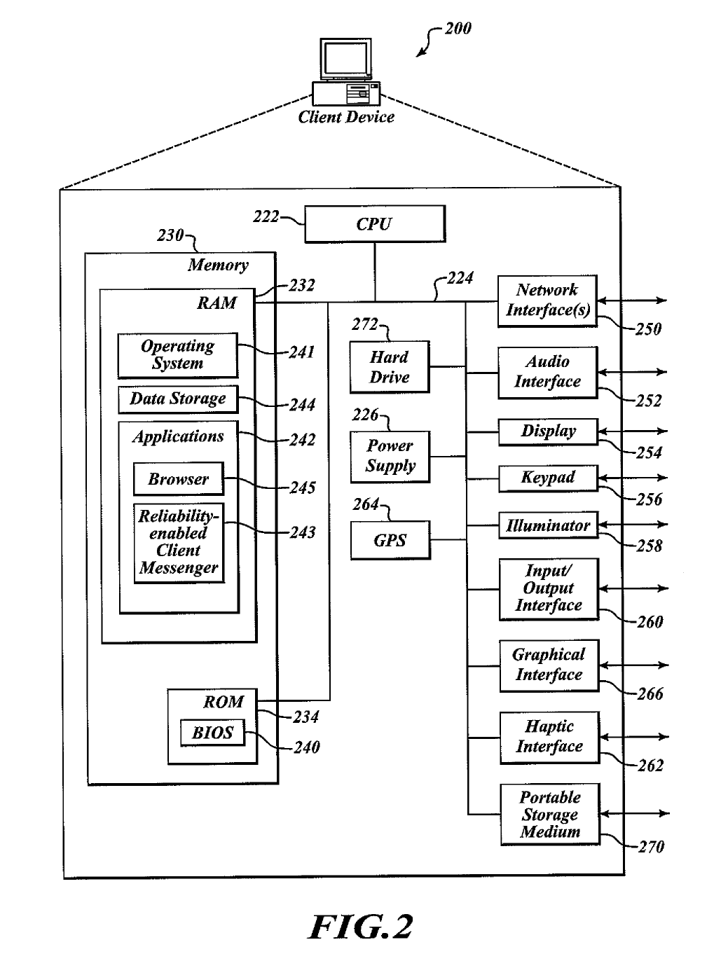

One embodiment of a client device usable as one of client devices 101-104 is described in more detail below in conjunction with FIG. 2. Briefly, however, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-104 also may include at least one other client application that is configured to receive content from another computing device, including, without limit, content services 108-109. The client devices 101-104 may also be configured to receive IM messages from other clients directly and/or via the IM services 107. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 101-104 may employ any of a variety of client applications to receive/send messages such as IM messages, and the like.

Wireless network 110 is configured to couple client devices 102-104 to network 105. Wireless network 110 may include any of a variety of wireless sub-networks that may further overlay stand-alone ad-hoc networks, and the like, to provide an infrastructure-oriented connection for client devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 105 is configured to couple IM services 107 and its components with other computing devices, including, client device 101, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between IM 107, and other computing devices.

Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

In one embodiment, IM transactions may be performed using a Peer-to-Peer (P2P) communication or via a server offering IM services. FIG. 1B is a block diagram of another embodiment of an IM system architecture related to providing reliable IM services. The IM system includes IM server 130, offline store 132, Connection Servers (CS) 126 and 128, and client devices 122 and 124. Client devices 122 and 124 may be any one of client devices 101-104 shown in FIG. 1A. Similarly, CS 126 and 128 may be connection server 106 and IM server 130 may be the server that offers IM services 107 shown in FIG. 1A. Those skilled in the art will appreciate that the IM system depicted in FIG. 1B is not limited to the shown components and any number of servers and client devices may be employed. For example, a server farm may be used to implement IM server 130 and/or CS 126 and 128 to provide load balancing and/or sufficient communication and service bandwidth for thousands or millions of clients.

In one embodiment, IM server 130 is used to offer IM services. IM 130 typically maintains state and/or profile information about the clients that are used to facilitate IM transactions. Such state information may include, but is not limited to, whether the client is a reliability-enabled client, what geographic area does the client belong to (for example, based on the client's IP address), what language the client uses for IM, or the like. In one embodiment, IM 130 includes a reliability-enabled server messenger component for handling incoming messages from sending clients, storing the incoming messages in offline store 132, sending/relaying outgoing messages to receiving or remote clients, and/or sending ACKS back on behalf of the receiving clients. IM 130 is coupled with CS 126 and 128, which are in turn used to connect clients 122 and 124 to IM 130. Those skilled in the art will appreciate that the same functionality depicted in FIG. 1B may be implemented using other arrangement of components without departing from the spirit of the present disclosures. For example, the functions performed by IM 130 and/or CS 126 and 128 may be integrated in one server. Conversely, the functions performed by each of these servers may be decomposed and distributed over different servers. For instance, in one embodiment, CS 126 and 128 may each perform basic low-level connection tasks while leaving user authentication to another server. In another embodiment, connection services such as authentication or accounting tasks may be performed by CS 126 and 128.

With continued reference to FIG. 1B, an IM message from a sending client, such as client 122, to a receiving or remote client, such as client 124, may take different paths. Communication end-points are where a message originates and where the message ends up. Therefore, a sending client, a receiving client, and a message storage, such as offline store 132, are all possible communication end-points. An IM message may be transmitted directly between two end-points or indirectly via IM services implemented by IM server 130. For example, the IM message may be transmitted directly from the sending client 122 to receiving client 124 via a P2P connection. In one embodiment, IM message may go through CS 126 coupled with sending client 122, to CS 128 coupled with receiving client 124, and finally to the destination end-point, receiving client 124. This message route “short-circuits” IM 130 and goes directly between CS 126 and 128 to streamline the process. In yet another embodiment, the IM message may traverse a path from sending client 122 to CS 126, onto IM 130, and back down to CS 128 and then to receiving client 124.

Generally, the fewer hops a message takes, the more efficiently it can reach the destination end-point from the source end-point. However, in some cases it may be necessary to take a longer message route in order to use certain services not otherwise available. For example, during an initial communication session, sending client 122 may not be aware whether receiving client 124 is reliability-enabled or not. Similarly, sending client 122 may not be able to establish a direct P2P connection with receiving client 124, perhaps residing in another country across many gateways, each with certain restrictions for passing through. Such situations may involve the IM to go through IM 130 which has state information about receiving client 124. In another alternative embodiment, a few initial IM messages may be sent through IM 130 in order to establish a connection with receiving client 124 and then subsequently through a P2P connection. Another situation where P2P communication may not be possible is when one client is not reliability-enabled and the other client is. In such a case, reliable communication may be performed through IM services offered by IM 130. Yet another situation where P2P communication may not be possible is when one client is offline. In this case, messages sent from sending client 122 may go to IM 130 and be stored in offline store 132 for later delivery to receiving client 124 when receiving client 124 comes online. Yet another situation where P2P communication may be precluded is when one client uses a different service than the other client. For example, one client may use the Yahoo!® IM service while the other client uses the MSN® IM service.

Offline store 132 is coupled with IM 130 to store messages for clients which may be offline at a time when another client sends the offline client a message. In one embodiment, offline store 132 is coupled with IM 130 locally. In another embodiment, offline store 132 may be coupled to a remote or third party server that is connected to IM 130.

### Illustrative Mobile Client Environment

FIG. 2 shows one embodiment of client device 200 that may be included in a system implementing the invention. Client device 200 may include many more or less components than those shown in FIG. 2. However, the components shown are sufficient to disclose an embodiment for practicing the present invention. Client device 200 may represent, for example, client devices 101-104 of FIG. 1A.

As shown in the figure, client device 200 includes a processing unit (CPU) 222 in communication with a mass memory 230 via a bus 224. Client device 200 also includes a power supply 226, one or more network interfaces 250, an audio interface 252 that may be configured to receive an audio input as well as to provide an audio output, a display 254, a keypad 256, an illuminator 258, an input/output interface 260, a haptic interface 262, and a global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery. Client device 200 may also include a graphical interface 266 that may be configured to receive a graphical input, such as through a camera, scanner, or the like. In addition, client device 200 may also include its own camera 272, for use in capturing graphical images. In one embodiment, such captured images may be evaluated using OCR 268, or the like.

Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications and/or other data. For example, data storage 244 may also be employed to store information that describes various capabilities of client device 200, a device identifier, and the like. The information may then be provided to another device based on any of a variety of events, including being sent as part of a header during a communication, sent upon request, or the like.

Applications 242 may include computer executable instructions which, when executed by client device 200, transmit, receive, and/or otherwise process messages (e.g., SMS, MMS, IMS. IM, email, and/or other messages), audio, video, and enable telecommunication with another user of another client device. Other examples of application programs include calendars, browsers, email clients, IM applications, VOIP applications, contact managers, task managers, database programs, word processing programs, security applications, spreadsheet programs, games, search programs, and so forth. Applications 242 may further include browser 245, and reliability-enabled client messenger component 243.

Reliability-enabled client messenger component 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols. The reliability-enabled client messenger component 243 implements reliability features for the reliable IM system, such as generating and associating an IM message ID, sending message-specific ACK, and resending IM messages that have not been acknowledged within a predetermined timeout period, as more fully described below.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. Thus, in one embodiment, browser 245 may interact with reliability enabled messenger component 243 to enable reliable IM message communications.

### Illustrative Server Environment

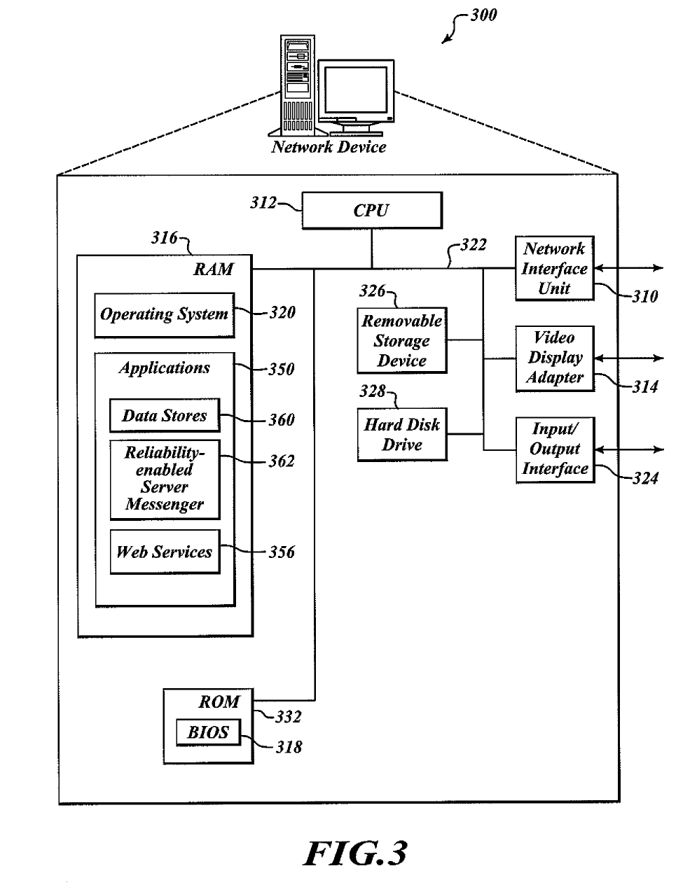

FIG. 3 shows one embodiment of a network device, according to one embodiment of the invention. Server device 300 may include many more components than those shown. The components shown, however, are sufficient to disclose an embodiment for practicing the invention. Server device 300 may represent, for example, IM server 130 discussed with respect to FIG. 1B.

Server device 300 includes processing unit 312, video display adapter 314, and a mass memory, all in communication with each other via bus 322. The mass memory generally includes RAM 316, ROM 332, and one or more permanent mass storage devices, such as hard disk drive 328, and removable storage device 326 that may represent a tape drive, optical drive, and/or floppy disk drive. The mass memory stores operating system 320 for controlling the operation of server device 300. Any general-purpose operating system may be employed. Basic input/output system (“BIOS”) 318 is also provided for controlling the low-level operation of server device 300. As illustrated in FIG. 3, server device 300 also can communicate with the Internet, or some other communications network, via network interface unit 310, which is constructed for use with various communication protocols including the TCP/IP protocol, Wi-Fi, Zigbee, WCDMA, HSDPA, Bluetooth, WEDGE, EDGE, UMTS, or the like. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Applications 350 may further include a reliability-enabled server messenger component 362 used to relay incoming IM messages sent by a sending client to a receiving client, store the IM messages if the receiving client is not accessible, and send ACKs back for the incoming IM messages to the sending client. In one embodiment, reliability-enabled server messenger component 362 sends the ACKs back to the sending client automatically. For example, if the receiving client is not reliability-enabled and/or is offline, reliability-enabled server messenger component 362 automatically sends an ACK back for a message received from the sending client.

### Illustrative Signal Diagrams and IM System Operation

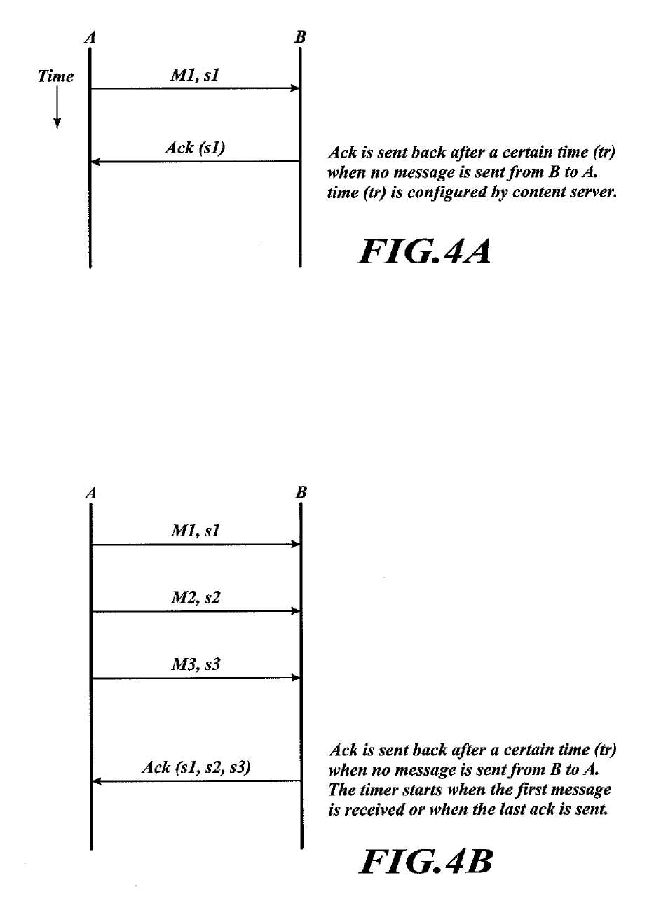

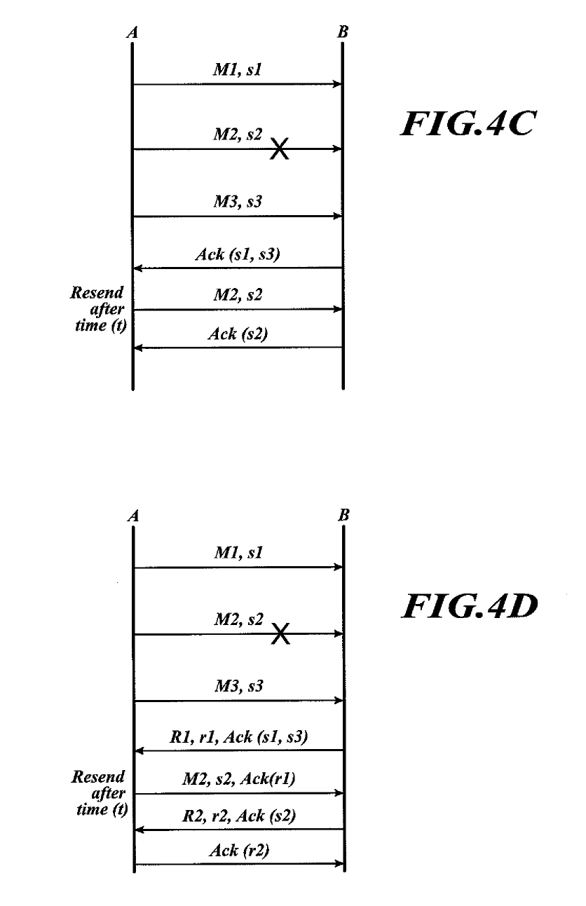

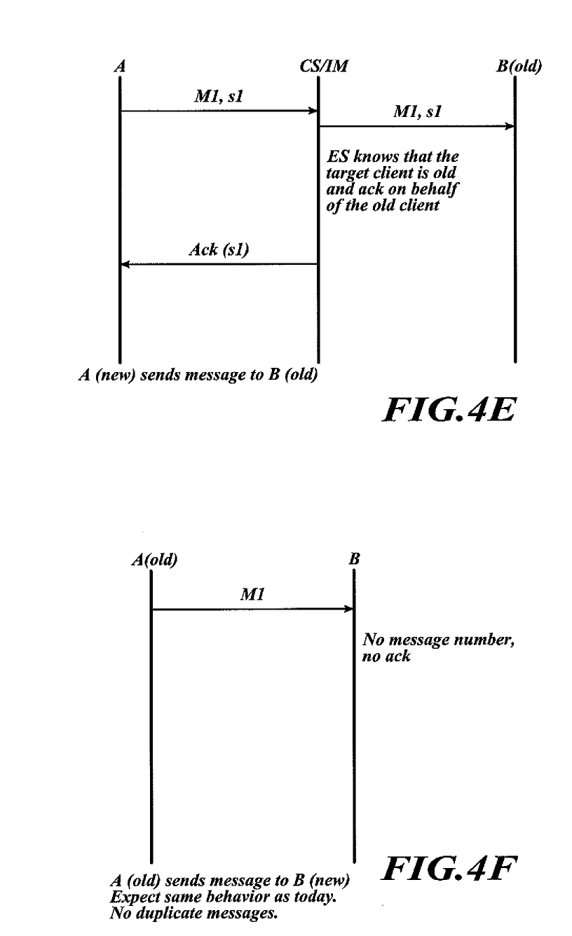

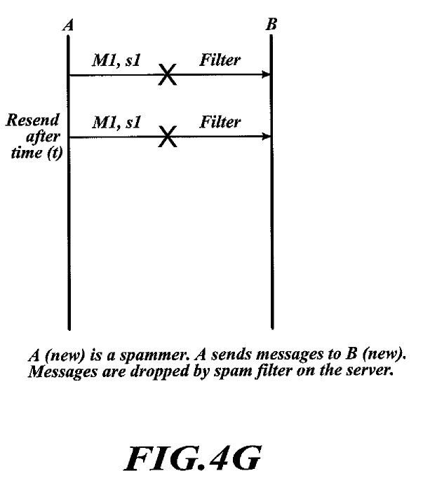

FIGS. 4A-4G are signal diagrams that show typical IM transactions between clients and/or IM servers. In FIGS. 4A-4G, end-points A and B may represent any of the client devices shown in FIG. 1A. Furthermore, the end-point “A” represents a sending client, such as client 122, while the end-point “B” represents a receiving client, such as client 124. IM server 130 is labeled as “IM,” as seen in FIG. 4E, for example. In one embodiment, the reliable IM system may treat the entire network as a black box with the connection servers acting as entry and exit points to the network. This arrangement may give primary responsibility for message acknowledgment to the client. In one embodiment, for message-specific acknowledgement, messages may include a message identifier (ID). An IM message including a message ID is a sequenced IM message in that each message sent is considered to have a position or ordered relationship with respect to other sent messages. The labels “A(old)” and “B(old)” represent those clients A and B, respectively, that are not reliability enabled. That is, clients which do not include the reliability-enabled messenger component 243. Similarly, labels “A(new)” and “B(new)” those represent clients A and B, respectively, that are reliability enabled. That is, clients which include the reliability-enabled messenger component 243.

Sequenced messages originating from client A are designated “Mi”, where “i” is a number such as 1, 2, and the like, used to designate the message's position in the sequence of messages. The message ID corresponding to Mi is designated “si”. Similarly, Sequenced messages originating from client B are designated “Rj”, where “j” is a number such as 1, 2, and the like. The message ID corresponding to Rj is designated “rj.” In one embodiment, “Rj” may be interpreted to mean “Response number j.” In another embodiment, a sequenced IM message MI originating from A may have no “request-response” type of relationship with another sequenced IM message RI originating from B. That is, generally, messages Mi and Rj originating from A and B, respectively, may be considered substantially independent with respect to timing of transmission and/or content of the messages.

An ACK may be sent as a standalone message or it may be sent as a “piggy back” message attached to another IM message originated from B to the A. The responding client waits a predetermined amount of time (tᵣ, described below) to see if an NM message is sent in the reverse direction (for example, from the receiving client, which received an original IM message from the sending client) so an ACK can be piggy backed onto the message sent in the reverse direction. After the predetermined time expires, B (or IM 130 on behalf of B(old) or when B is offline) sends a standalone ACK.

In one embodiment, the reliable IM system may be turned on or off by setting a flag, for example, a Boolean variable. This feature may be desirable for testing system performance, network diagnostic, or the like. If the reliable IM system is set to be off, the clients and the IM server, IM 130 will work normally without sequencing messages and without sending or waiting for ACKs. Otherwise, if the reliable IM system is set on, then messages are sequenced by including a message ID, such as s1, for each sequenced message, such as M1, and sending and waiting for ACKs for each sequenced message.

In one embodiment, a number of timeout and queue control parameters are used to control the behavior and timing of the reliable IM system. Message queues are described more fully below with respect to FIG. 6. These control parameters that control the sending of ACKs and management of IM message queues may be obtained and used by the clients from IM server 130. Furthermore, these parameters may be adjusted, either dynamically or from time to time, based on network traffic, client capabilities, geographic locations, or other factors and considerations.

One of the control parameters is ACK timeout, tᵣ, which is used to determine when to send a standalone ACK and when to piggy back the ACK on another IM message in the reverse direction, for example, from B to A. The ACK timeout value tᵣ may be set to any reasonable value, such as two seconds. The ACK timeout tᵣ is viewed from the perspective of the receiving client. In one embodiment, tᵣ is dynamically adjustable based on various parameters and/or statistics, such as communication latency between the particular clients communicating. If B sends a message R1 to A before tᵣ expires, then the ACK for M1 (the message initially sent from A to B) may be attached to R1 and sent to A. Otherwise, a standalone ACK including the message ID s1 to acknowledge the receipt of message M1 may be sent. In one embodiment, client messenger component 243 on client device 200 (see FIG. 2) generates message ID s1 and manages ACKs, as more fully described below with respect to FIG. 6.

Another control parameter used for controlling ACKs and managing IM messages include the maximum queue clearance time, t_{qm}, which represents a time the client can be logged out and/or disconnected without clearing all of the client's send and receive queues, as more fully described below with respect to FIGS. 6, 10, 11.

Another control parameter, the message give-up timeout period, t_{g}, may be used to determine when to give up waiting for a particular sequenced message M2 to arrive, and report an error back up to the user of the client device indicating that message M2 is lost. That is, if B receives several sequenced messages M1, M3, M4 from A, and B determines that one of the sequenced messages M2 is missing (for example, has not been received by B), B may give up waiting for the missing sequenced message M2 after t_{g} seconds since the arrival of the next message M3.

Yet another control parameter, the resend timeout period, tₛ, the time period used to determine when to resend a lost IM message. A resends the sequenced message M1 if the corresponding ACK for M1 has not arrived from B within tₛ seconds after sending M1. The resend timeout period ts is generally greater than the ACK timeout period tr. The resend timeout tₛ is determined from the perspective of the sending client, A.

Still another control parameter, client receive IM queue size limits, represents the number of entries in the queue data structure, define a minimum or a maximum value for IM queue size. The queue data entries may hold information associated with the IM messages, such as the message ID or a pointer to the entire IM message. The receive IM queue size limits are described in greater detail with respect to FIG. 6 below. Typical settings for the minimum and maximum queue size values are 10 and 30 entries, respectively.

Still another control parameter, the number of maximum retries, Nₘₐₓᵣₑₜᵣᵢₑₛ, represents the maximum number of times that A resends a sequenced message M1 for which no ACK has been received. After Nₘₐₓᵣₑₜᵣᵢₑₛ resends, A may give up resending M1 and may generate an error message indicating the loss of M1 to the user of client device A.

In FIGS. 4A-4G, the vertical axis represents time, making the transactions shown lower in the figures the latest in time, as indicated by the downward arrow in FIG. 4A. In one embodiment, the message ID may be generated on a per-IM-session basis between the two clients A and B. If one of the clients starts another IM session with a third client, a new set of message IDs are started for the other IM session. In another embodiment, the message ID may be based on a GUID (Globally Unique ID) that is unique across sessions and is never repeated. In one embodiment, the message ID serves only as a sequence number identifying order of the messages in an IM session, while in other embodiments, the message ID may include multiple fields that may be parsed at the receiving end and/or by the IM servers to extract various information about the source of the message, such as IP address, timestamp, message type, and other meta data that may be of use in collecting various statistics, controlling a state of communications, authentication, authorization, and the like. Once the sequenced message M1 is received by receiving client B, receiving client B sends an ACK back to sending client A for the sequenced M1 message.

Now, with reference to FIG. 4A, A sends an IM message M1 with message ID, s1, to B. B sends back an ACK(s1), indicating that ACK(s1) represents a standalone acknowledgement of M1, after the expiration of ACK timeout, tᵣ seconds, when no message is sent from B to A.

As shown in FIG. 4B, A sends multiple sequenced messages M1, M2, M3, with message ID's, s1, s2, and s3, respectively, to B. In response, B may send a single corresponding ACK for M1, M2, and M3 in one standalone ACK message as ACK(s1, s2, s3), after the expiration of ACK timeout, tᵣ seconds.

As shown in FIG. 4C, A sends sequenced messages M1, M2, and M3 to B. M2 is shown as being lost in transmission and is not received by B. After the expiration of ACK timeout, tᵣ seconds, B sends standalone ACK(s1, s3) for M1 and M3, respectively. After the expiration of the resend timeout, ts seconds, A resends M2 to B, then B sends ACK(s2) to A. A message and/or an ACK may be lost for many reasons. For example, if there is a change in client network configuration (such as adaptor change, switch to different wireless network, etc.), the client might enter a state where messages cannot be sent out (such as a socket error, or the like). Another reason for loss of a message and/or ACK may be when an anti-spam filter in the client and/or server drops a message from a client that is identified as a spammer. Other reasons include network failures, server crashes, and the like.

As shown in FIG. 4D, A sends sequenced messages M1, M2, and M3 to B. M2 is shown as being lost in transmission and is not received by B. Before the expiration of ACK timeout, tᵣ, B sends an IM message R1 to A and attaches ACK(s1, s3) for M1 and M3, respectively, as piggy back attachments. After the expiration of the resend timeout, ts seconds, A resends M2 to B with a piggy back ACK(r1) for R1. B sends another message R2 to A with a piggy back ACK(s2) for M2. A sends standalone ACK(r2) to B after the expiration of ACK timeout, tᵣ to acknowledge receipt of 1R2 from B.

As shown in FIG. 4E, client B(old) is not reliability-enabled. A sends a message M1 to B(old) through IM 130. In one embodiment, transmitting from A to B may be performed transparent to A. That is, A may not be aware of the presence of IM 130, in the communications with B. Thus, the destination for the message M1 remains B, and IM 130 operates as a reliability proxy. IM 130 forwards the message to B(old) and automatically sends an ACK(s1) back to A on behalf of B(old). In one embodiment, IM 130 ascertains the capabilities of each client, including whether the client is reliability-enabled, using a capability matrix. In one embodiment, a capability matrix may be implemented using a bit map where each bit represents a particular capability, such as being reliability-enabled, and is set to 1 (one) or 0 (zero) indicating whether the particular capability is present/supported or not, respectively. The invention is not limited to this approach, others may also be used.

In FIG. 4F, client A(old) is not reliability-enabled. A(old) sends a message M1 without a corresponding message ID s1. B is a reliability-enabled client and determines, based on the missing message ID s1, that A is not reliability enabled. B does not send an ACK back to A(old).

As shown in FIG. 4G, A is identified as a client, which is not authorized to send IM messages to B. For example, A may be on B's “ignore list,” for messages. A may be identified as a “spammer” that is placed on a “black list,” from which messages are filtered out and are not delivered. In any event, A sends a message M1 to B. A spam filter intercepts M1 and drops it. A resends M1 after the expiration of the resend timeout, ts seconds. The spam filter intercepts M1 again and drops it. B never receives M1 and never sends an ACK to A.

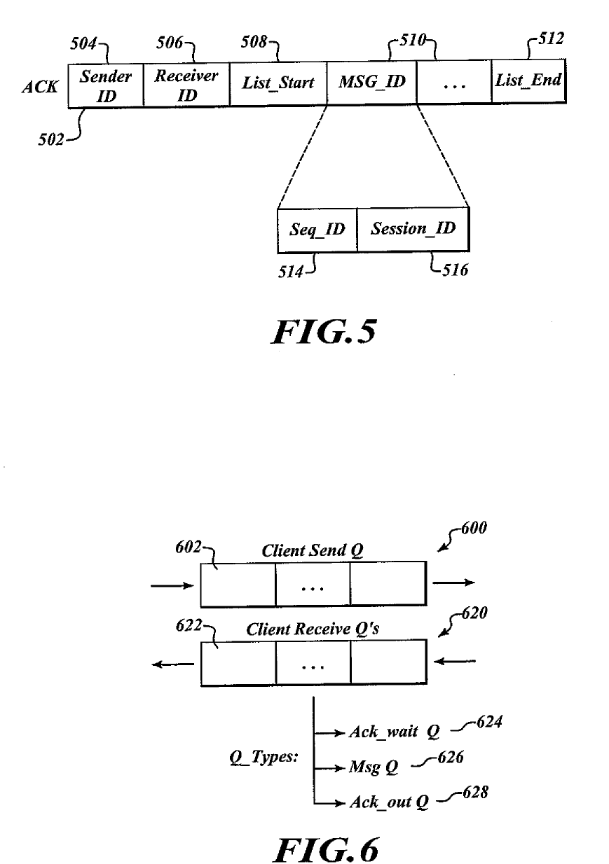

As noted above and shown in FIGS. 4A-4G, many sequenced messages may be sent from A to B before a corresponding ACK can be received back at A from B. In such cases, multiple ACKS are packaged together and sent as part of one ACK back to the transmitting end-point, for example, sending client 122. For example, FIGS. 4B, 4C, and 4D show some such scenarios. Therefore, the format for the ACK packet is configured to support multiple ACKs in a manner such that the sending client that receives the ACK packet can ascertain which of the send sequenced messages has been ACK'd and which ones are still waiting for a corresponding ACK. FIG. 5 is a block diagram of an embodiment of an ACK format and a sequenced message ID. ACK packet 502 includes five types of fields: Sender-ID field 504, Receiver-ID field 506, List-Start field 508, ID-List 510 of one or more message ID's, and List-End 512. Sender-ID 504 carries information that identifies the sending client 122.

Sender-ID 504 may include an IP address, a client name or designation, a registered client number or ID, or any type of information that can sufficiently identify sending client 122 to receiving client 124 and/or IM server 130. Receiver-ID 506 may include information similar to the information in Sender-ID 504.

List-Start 508 and List-End 512 are delimiters of ID-List 510 indicating the start and end of ID-List 510, respectively. List-Start 508 and List-End 512 may include a fixed pattern of data to differentiate them from the message ID's included in ID-List 510. The fixed pattern may be an “out-of-band” set of characters, such as special ASCII characters, that are generally not used in forming message ID's. For example, if the message ID's are numerical only, then the fixed pattern may be some combination of alphabetical characters. Alternatively, if the message ID's are assigned to be within a predetermined numerical range, such as 1-10,000, then the values of List-Start 508 and List-End 512 may be assigned to be a number outside the predetermined numerical range, for example 0 and 11,000, respectively. Those skilled in the art will appreciate that there are many other ways for implementing delimiters in a communication packet.

In one embodiment, ID-List 510 includes message ID entries, each of which has two fields, sequence ID 514 and session ID 516. Session ID 516 identifies a communication session in which the sender of the message is involved. For example, sending client 122 may have two different IM communication sessions with two receiving clients at the same time. The messages going to each of the receiving clients will have different session ID's 516. Within a given communication session, each sequenced message has a unique sequence ID 514. The sequence ID's in different communication sessions may be different or the same and have no direct relationship with each other outside their respective sessions. For example, two sequenced messages can both have a message ID of 100 within their respective sessions having session ID's of 10 and 20, without ambiguity because each message is identified by the combination of both session ID 516 and sequence ID 514. Therefore, in this example, the message ID of a first sequenced message is 100-10, while a second sequenced message has a message ID of 100-20. In one embodiment, message sequence ID 514 is a 32-bit number that starts with a 32-bit random number and increments sequence ID 514 by 1 for the next message sent.

Those skilled in the relevant arts will appreciate that packet sequencing in a communication protocol may be implemented at multiple levels of the OSI communication model independently for different units of data. For example, while frame numbers may be assigned to a frame of data at a data link layer, ordered delivery of frames may be implemented at a transport layer like TCP. As such, a message entered at the application layer of OSI may be broken down into multiple packets at TCP layer, and each packet at the TCP layer may further be broken down into multiple frames at the data link layer. Each lower layer may implement its own reliability and data unit management mechanisms independently of other layers. Therefore, a message and its corresponding ACK at the application layer are distinct from another data unit, such as a frame or packet, and the ACK response for the other data unit at the data link layer or transport layer.

The sequenced messages that are sent or received are placed in message send or receive queues, respectively. In one embodiment, the message queues are implemented in memory as arrays or linked lists. In another embodiment, message queues may be implemented on hard disks or other non-volatile storage such as flash memory, so the queue data are persistent across disconnections, logouts, etc. Since each client is generally both a sender and a receiver of IM messages, a reliability enabled client may have two sets of queues for message management: one set of queues for sending messages, and one set of queues for receiving messages. IM server 130 is generally a receiver of IM messages on behalf of clients and therefore IM server 130 typically includes at least receive queues. However, IM server 130 may include other queues and data structures for managing incoming and relayed messages as well as for managing ACKs. FIG. 6 is a block diagram of an embodiment of the send and receive queues.

In one embodiment, on the sending side, the client includes send queue 600 which includes multiple entries 602. A message is placed on send queue 600 until the corresponding ACK is received by the sending client. When a message is sent, it can either be sent via CS 126 (or CS 128) or by a P2P connection of FIG. 1B. At this time the message will be place in ACK-wait queue 624 to wait for receiving the corresponding message ACK. When a message is received at the sending client, it is determined if the received message has a sequence number and/or an ACK. If it has a sequence number, that is, if the received message is sent by a reliability-enabled client, then the received message is placed in receive message queue 626 and a corresponding ACK is sent out for the received message. If the received message also has a piggy back ACK, then the message ID of the piggy backed ACK is checked to see if it is in ACK-wait queue 624. If so, then the sent message with the corresponding ID is deleted in send queue 600, unless deleting the sent message results in a send queue with less than a minimum queue size, for example 10 queue entries. In that case, a delete command will be scheduled until send queue 600 grows bigger than the minimum queue size. Send queue 600 size can go down to 0 when all the messages are sent successfully, e.g., all ACKs are received and there are no more messages to be sent.

In one embodiment, on the receiving side, the client includes a set of three queues: ACK-wait queue 624, message queue 626, and ACK-out queue 628. The receive queues have a minimum length. In one embodiment, the message payload is stored as a hash of the real message. Client message queue 626 may be encrypted to avoid a system user from reading cached messages or message ID's from receive message queue 626. Receive message queue 626 may be reset every time a user exits the IM messaging application or messenger 243 crashes. Receive message queue 626 lives for t_{qm} seconds after the IM user logs out. For example, if a user switches from wireless VPN (Virtual Private Network) to normal LAN connection, the switching causes messenger to logout. In this case, message queue 626 may live for t_{qm} seconds. In other words, all undelivered messages may be resent if the user logs back on to messengers within t_{qm} seconds.

ACK-out queue 628 may be used to manage incoming messages from a remote client that must be acknowledged to the remote client either as a piggy-back ACK or as a stand-alone ACK after tᵣ seconds after the incoming message has been received.

Generally, in a P2P communication the reliability-enabled sending client obtains the capability matrix from the receiving client to ascertain whether the receiving client is reliability-enabled. If the receiving client is reliability-enabled, then the sending client can employ the reliable messaging techniques described above. Otherwise, the sending client will not employ these techniques and communicates accordingly. When communicating through IM server 130, IM server 130 takes on the responsibility of ascertaining which clients in the communication session are reliability-enabled and which ones are not. IM server 130 behaves accordingly and sends ACKs back to a reliability-enabled sending client on behalf of the non-reliability-enabled receiving client, as, for example, in FIG. 4E. In general, when the sending client is reliability-enabled, IM server 130 sends back an ACK for messages received from the sending client unless the receiving client is determined to also be reliability-enabled, in which case, the receiving client sends back the ACK. However, if IM server 130 determines that the message sent by the sending client cannot be delivered for some reason (e.g., network connection problems), then IM server 130 sends the ACK back even though the receiving client is reliability-enabled. Ideally the server component that is farthest from the sending client (for example, closest to receiving client) sends an ACK back to rule out un-reliable factors internal to the server. However for practical reasons an intermediate server component may be chosen also. ACKs sent back by IM server 130 look like the ACKs have been sent by the receiving client.

In cases where the sent message cannot be delivered by IM server 130, for example, because the receiving client is offline, the sent messages are stored in offline store 132 for later delivery when the receiving client comes online. Offline store 132 deletes messages that are delivered to the receiving client after receiving a corresponding ACK for the delivered message to maintain the end-to-end reliability of the IM system.

To determine and optimize various timeout values, such as tᵣ, tₛ, and t_{qm}, and increase overall reliability, various metrics and statistics may be collected by the client and/or IM server 130. The various metrics and statistics include, but are not limited to, number of resend messages in a client, number of duplicate messages received, number of drop messages, average time delay between sending a message and receiving the corresponding ACK, among others.

In a server-based IM session, if the sending client sends a message to a group of receiving clients, IM server 130 in turn sends the message to each of the other receiving clients in the group. A different message ID is assigned to each message sent to each corresponding receiving client in the group, because communication with each receiving client constitutes a different session. If one of the receiving clients does not respond with an ACK, the sending client resends the sent message to the receiving client that did not send an ACK back, as if the resent message were a single IM text message for a single receiving client, as opposed to a message sent to a group of receiving clients.

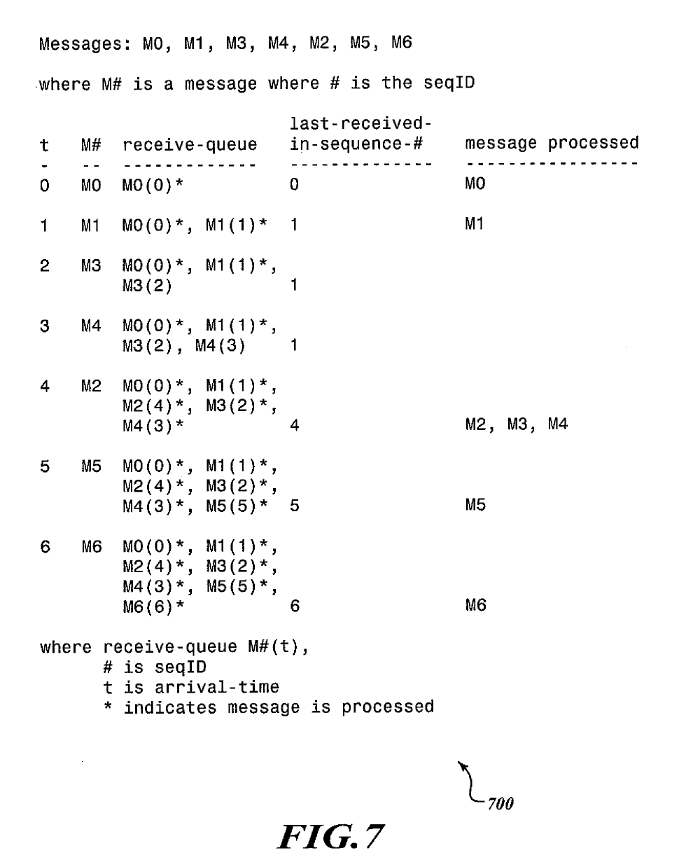

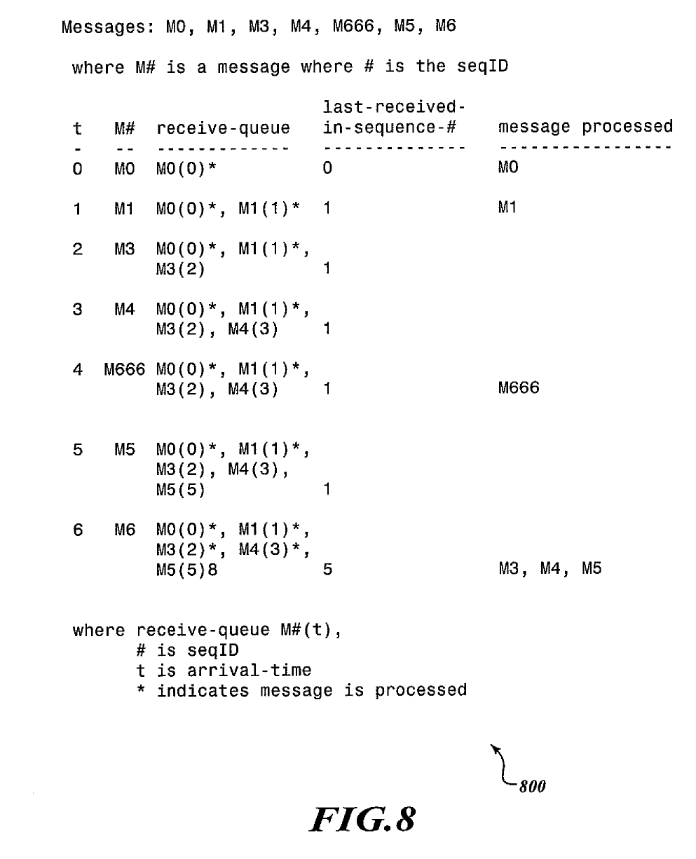

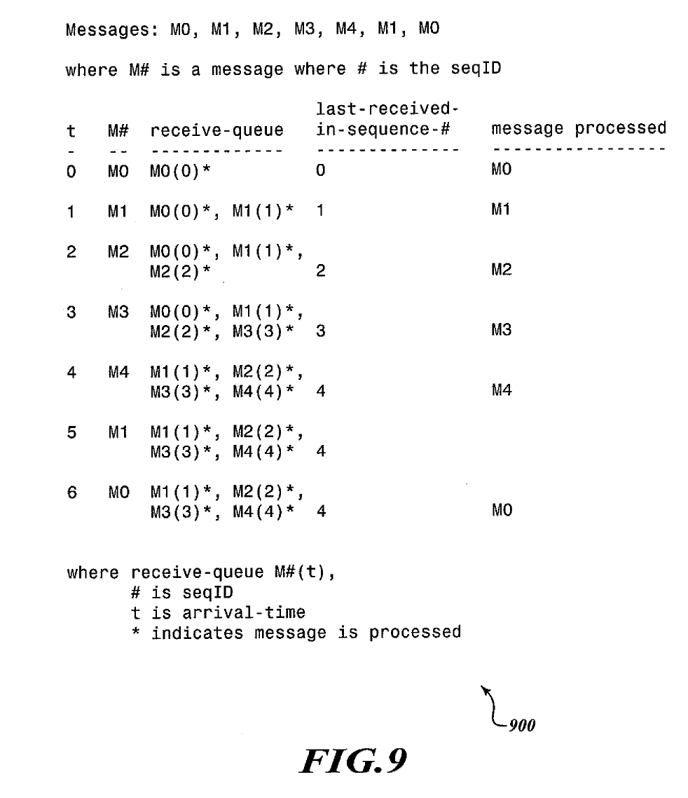

Aspects of the operation of the receive queues, including ACK-wait queue 624, message queue 626, and ACK-out queue 628, are shown in FIGS. 7-9. FIG. 7 shows an ordinary sequence of messages, FIG. 8 shows queue transactions when an out of sequence and/or corrupt message is received and give-up timeout t_{g} expires, and FIG. 9 shows the queue transactions when a duplicate message is received.

In FIG. 7, messages M0-M6 arrive in order, are received in the receive message queue 626, and processed, for example, acknowledged, in the same order.

In FIG. 8, messages M0-M1, M3-M4 and M5-M6 arrive in order, however, message M666 arrives out of order and M2 is missing. Message M666 (message ID 666) may be considered a corrupt message and/or a corrupt message ID. After the elapse of three seconds (message M666 arrived at t=3 sec), the sequence ID of M666 cannot reasonably be expected to jump from 4 (sequence ID of M4) to 666, since the sequence ID is incremented by 1 (one) for each new message, and assuming 10 messages were sent per second. Therefore, message M666 is dropped from the message queue 626 and is not acknowledged. Assuming the give-up timeout t_{g}=2 sec., and M2 has not been received within that period, M2 is given up as lost.

With reference to FIG. 9, messages M0-M4 arrive in order, but duplicate message M1 arrives after M4. Since M1 is still in the message queue 626 at time t=5 when the second M1 is received, the second M1 is considered to be a duplicate and is discarded.

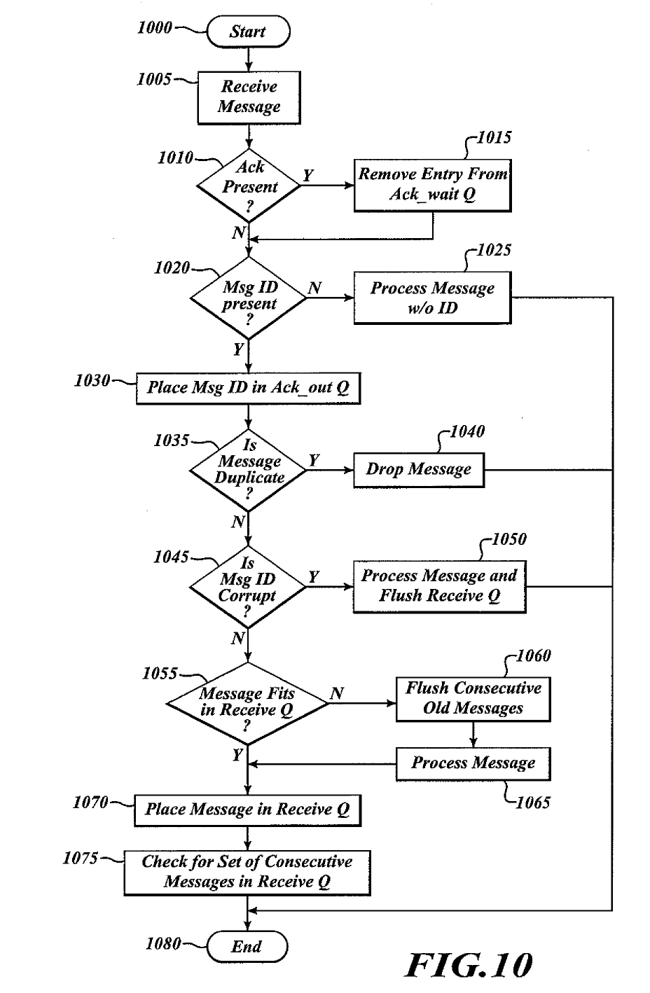

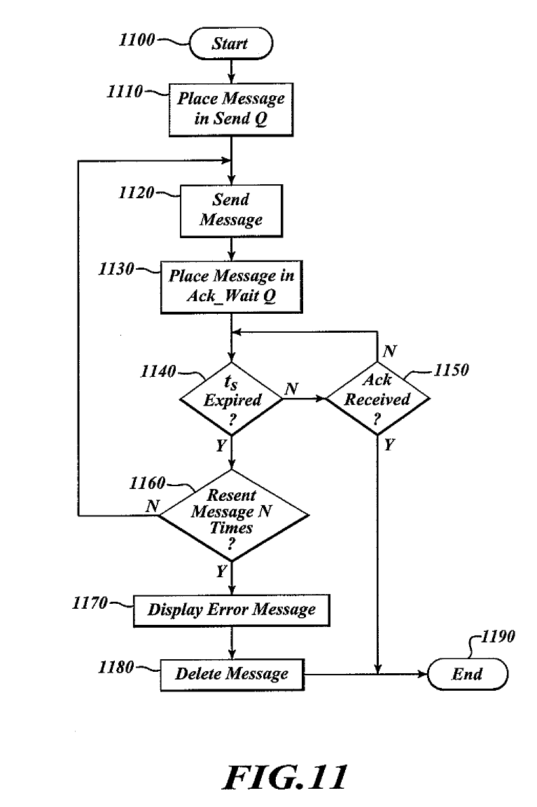

The overall receive and send operations are depicted in the flow diagrams of FIGS. 10 and 11, respectively. With reference to FIG. 10, the receive operation starts at block 1000 and proceeds to block 1005 where a message is received from a remote client. At block 1010 it is ascertained whether an ACK is present in the received message, for example, as a piggy back attachment. If so, at block 1015 a message ID associated with the ACK is extracted and compared with the message ID's associated with messages waiting in ACK-wait queue 624. If a message with the same message ID associated with the ACK is found in ACK-wait queue 624, the message is removed from ACK-wait queue 624. If no ACK is present in the received message, the process proceeds to decision block 1020 where it is ascertained whether a message ID is present. If no message ID is present, the process moves to block 1025 where the received message is processed as a message from a non-reliability-enabled remote client. The process proceeds to block 1080 where the processing of the received message terminates. If a message ID is present, then the received message is from a reliability-enabled remote client and the message ID is placed in message ACK-out queue 628 at block 1030 so that an ACK including the message ID can be sent back to the remote client.

At decision block 1035, it is determined whether the received message is a duplicate message, as discussed above with respect to FIG. 9. If so, the received message is dropped at block 1040 and the process proceeds to block 1080 where the processing of the received message terminates, otherwise the process moves to decision block 1045 where it is determined whether the message ID is corrupt, as discussed above with respect to FIG. 8.

If the message ID is corrupt, at block 1050 the message is processed. The message queue 626 is flushed, and the process proceeds to block 1080 where the processing of the received message terminates. At decision block 1055, it is determined whether message queue 626 has an empty entry left to include the received message, that is, message queue 626's maximum size has not yet been exceeded. If there is no empty entry remaining in the queue, the oldest M consecutive messages in message queue 626 are flushed to make room for the new received message. Those skilled in the art will appreciate that other queue flush policies may be used without departing from the spirit of the disclosure. For example, the queue may be flushed based on a priority of the messages, determined based on some criteria such as origin of the message, in the queue instead of age of the messages.

At block 1065 the received message is processed and the process moves to block 1070 where the received message is placed in receive queue 626. At block 1075, the process searches for a set of consecutive messages in the message queue 626 to process consecutively numbered messages together, since consecutively numbered messages are in order, are not corrupted or missing, and are ready for processing.

With reference to FIG. 11, the send process starts at block 1100 and proceeds to block 1110 where an outgoing message having a message ID to be sent out to a remote client is placed in send queue 600. At block 1120, the message is sent to the remote client. At block 1130, the message is also placed in ACK-wait queue 624 to wait for and ACK to come back from the remote client or from IM server 130, as described above with respect to FIG. 6.

At decision block 1140, it is ascertained whether the resend timeout tₛ has expired. If not, it is not determined, at decision block 1150, whether an ACK with the message ID of the outgoing message has been received. If so, the process ends at block 1190, otherwise, the process goes back to decision block 1140.

At decision block 1140, if tₛ has expired, the process proceeds to decision block 1160 to determine whether the number of resends for this outgoing message has been exhausted. If so, an error message is displayed to the user on the client device at block 1170 and the outgoing message is deleted at block 1180. Otherwise, the process proceeds back to block 1120 where the outgoing message is resent.

Those skilled in the art will appreciate that the reliable IM methods may be embodied in various combinations of hardware and software partitioned between the clients, the IM server 130, and other server components such as CS 126 and 128 based on various considerations of cost, feasibility, control, and other constraints, without departing from the spirit of the present disclosure.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A client device for sending and receiving IM messages, the apparatus comprising:
a transceiver to send and receive data over a network; and
a processor that is operative to perform actions, comprising:
sending a first message over the network to another client device;
determining if an acknowledgement is received within a timeout period for the first message; and
if the acknowledgement is determined to have not been received within the timeout period, re-sending the first message to the other client device.

2. The client device of claim 1, wherein the processor is operative to perform actions, further comprising:
sending a second message over the network to the other client device; and
receiving an acknowledgement that includes acknowledging receipt of the first message and the second message.

3. The client device of claim 1, wherein the acknowledgement is received piggybacked onto a new message from the other client device.

4. The client device of claim 1, wherein the acknowledgement is sent from an intermediate IM server on behalf of the other client device.

5. The client device of claim 1, wherein the first message includes a message ID, the message ID including a sequence ID and a session ID.

6. A server device for managing IM messages, the system comprising:
a transceiver to send and receive data over a network;
an offline storage; and
a processor that is operative to perform actions, comprising:
receiving a first message from a first client device over the network;
storing the first message in the offline storage;
forwarding the first message to a second client; and
automatically sending an acknowledgement to the first client for the first message on behalf of the second client.

7. The server device of claim 6, further comprising:
a reliability-enabled messenger component to obtain information about the first and the second client to determine the capabilities of the first and the second clients to handle acknowledgments.

8. The server device of claim 6, wherein the first message includes a message ID.

9. The server device of claim 6, wherein the acknowledgement includes a message ID associated with the first message.

10. The server device of claim 6, wherein the acknowledgement includes multiple message IDs for corresponding multiple messages sent by the first client device.

11. A method of sending an TM message over a network, the method comprising:
sending a first message over the network to another client device;
determining if an acknowledgement is received within a timeout period for the first message; and
if the acknowledgement is determined to have not been received within the timeout period, re-sending the first message to the other client device.

12. The method of claims 11, further comprising:
re-sending the first message a predetermined number of times if an acknowledgement is not received for each of the re-sent first messages within the timeout period.

13. The method of claims 11, wherein the first message includes a message ID and the acknowledgement for the first message includes the message ID.

14. The method of claim 11, wherein the first message includes a message ID, the message ID including a sequence ID and a session ID.

15. The method of claim 11, wherein the acknowledgement includes multiple message IDs for corresponding multiple messages sent by the first client device.

16. A processor-readable storage medium having instructions encoded thereon that when executed cause the following actions to be performed:
sending a first message over the network to another client device;
determining if an acknowledgement is received within a timeout period for the first message; and
if the acknowledgement is determined to have not been received within the timeout period, re-sending the first message to the other client device.

17. The processor-readable storage medium of claim 16 having instructions encoded thereon that when executed further cause the following actions to be performed:
sending a second message over the network to the other client device; and
receiving an acknowledgement that includes acknowledging receipt of the first message and the second message.

18. The processor-readable storage medium of claim 16, wherein the acknowledgement is sent from an intermediate IM server on behalf of the other client device.

19. The processor-readable storage medium of claim 16, wherein the other client device is configured to not send the acknowledgement for the first message.

20. The processor-readable storage medium of claim 16, wherein the first message is stored in an offline storage and the acknowledgement is sent from an intermediate messaging server on behalf of the other client device when the other client device is offline.
